(19) United States
(12) Patent Application Publication
(10) Pub. No.: US 2007/0281133 A1
(43) Pub. Date: Dec. 6, 2007

(54) MOLDED ARTICLE INCLUDING DECORATIVE ELEMENT AND METHOD OF ATTACHING A DECORATIVE ELEMENT TO A VEHICLE COMPONENT

(75) Inventors: Nels R. Smith, Holland, MI (US); Scott A. Hansen, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/752,778

(22) Filed: May 23, 2007

Related U.S. Application Data
(60) Provisional application No. 60/808,338, filed on May 25, 2006.

(51) Int. Cl. B29C 43/18; B29C 59/02

(52) U.S. Cl. 428/161; 264/263; 264/293; 156/245

(57) ABSTRACT

A method of making a vehicle panel includes forming a coverstock, forming a decorative element to at least partially conform to the coverstock, positioning the coverstock and the decorative element into a mold, and molding a substrate to the coverstock, thereby bonding the decorative element to the coverstock.

### CROSS-REFERENCE TO RELATED PATENT APPLICATIONS

This application claims priority from U.S. Provisional Application No. 60/808,338, filed May 25, 2006, incorporated herein by reference in its entirety.

### BACKGROUND

The following background is provided simply as an aid in understanding the disclosed device and is not admitted to describe or constitute prior art.

The present application relates generally to the field of molded articles or components having a substrate, a coverstock, and a decorative element coupled to the coverstock. More particularly, the present invention relates to a method of attaching a decorative element, such as a film, to a coverstock that is molded to a substrate.

It is known to provide a decorative element on a vehicle trim panel by thermoforming the film and then molding a plastic backing behind the film to form a film subassembly. The film subassembly typically would then be attached to the finished panel by heat staking or other mechanical attachment. It is also generally known to provide a laminated panel that includes a coverstock for a mold-behind or partial-mold-behind process. Such coverstocks or laminates are thermoformed into a “pre-form” and then welded to the adjacent laminated “pre-form.” However, such known methods often require significant labor and/or fixturing during assembling, may have craftsmanship issues (e.g., gaps between the decorative element and the trim panel, noise during consumer use, etc.), or be susceptible to breakage or detachment.

Accordingly, it would be desirable to provide a method of attaching a decorative element to a component that reduces or eliminates capitol and labor-intensive processes such as the welding process(es) of conventional mold behind and partial mold behind processes.

It also would be desirable to provide a method of attaching a decorative element to a component that reduces or eliminates undesirable noise (e.g., buzzes, squeaks, rattles, etc.) and/or craftsmanship issues associated with traditional mechanical attachments of a pre-molded subassembly.

It also would be desirable to provide a method of attaching a decorative element to a component where the decorative element is interchangeable or easily adaptable or modified.

It also would be desirable to provide a method of attaching a decorative element to a vehicle interior component such as a trim panel, overhead system, instrument panel, or the like of a type disclosed in the present application that includes any one or more of these or other advantageous features.

To provide an inexpensive, reliable, and widely adaptable in-molded decorative element that avoids the above-referenced and other problems would represent a significant advance in the art.

### SUMMARY

One embodiment relates to a method of making a vehicle panel, comprising forming a coverstock, forming a decorative element to at least partially conform to the coverstock, positioning the coverstock and the decorative element into a mold, and molding a substrate to the coverstock, thereby bonding the decorative element to the coverstock.

Another embodiment relates to a method of making a molded article, comprising providing a coverstock having a groove and a decorative element having a flange. The method further includes applying the decorative element to the coverstock such that the flange engages the groove, positioning the coverstock and the decorative element in a mold, and introducing a substrate material into the mold to form a substrate.

Yet another embodiment relates to a molded article comprising a coverstock comprising a groove, a decorative element coupled to the coverstock by an adhesive and having a flange at least partially received within the groove, and a substrate molded behind the coverstock.

Further embodiments relate to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments.

### BRIEF DESCRIPTION

FIG. 1 is a perspective view of a vehicle according to an exemplary embodiment.

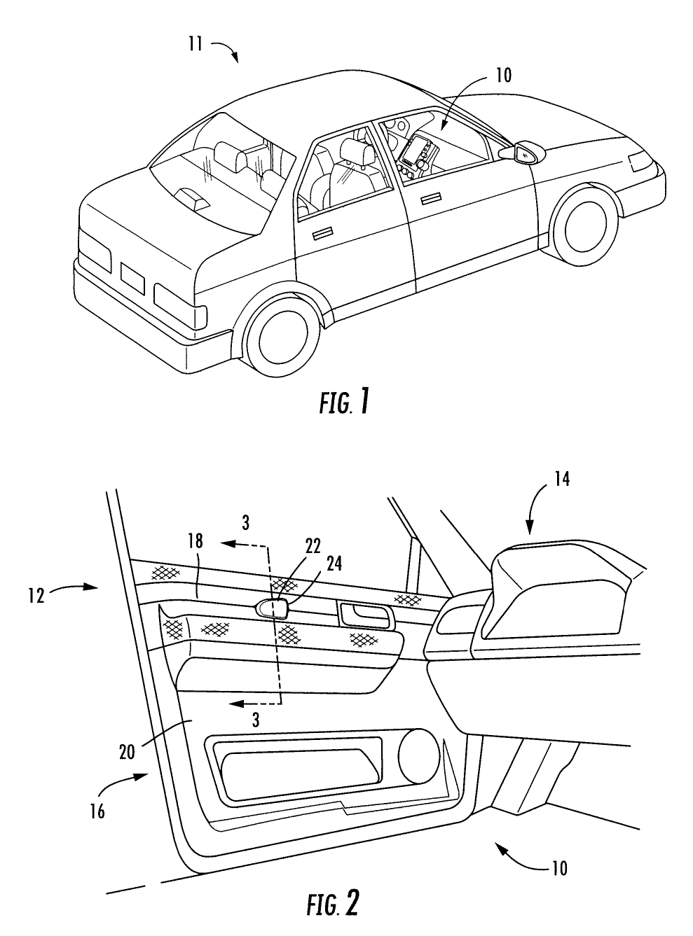

FIG. 2 is a perspective view of a portion of the interior of the vehicle of FIG. 1 including a trim panel according to an exemplary embodiment.

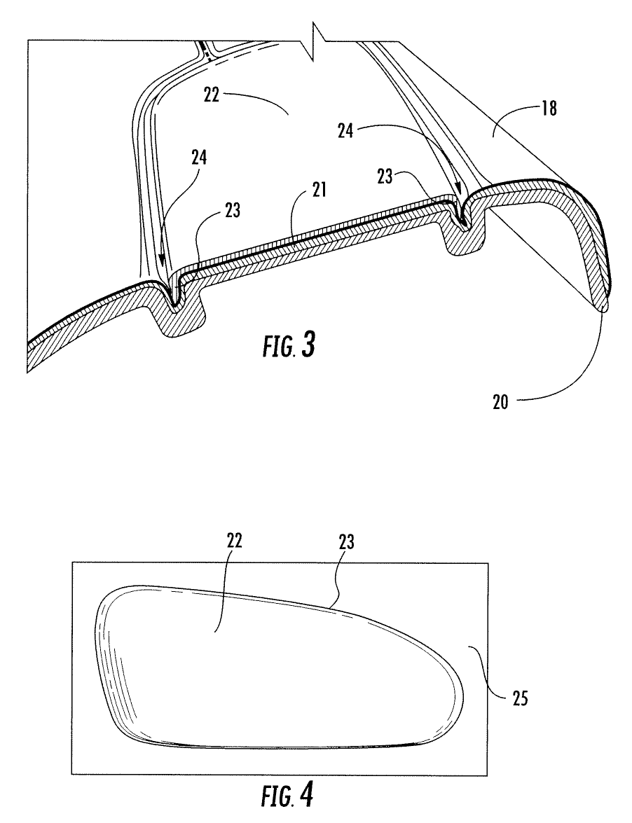

FIG. 3 is a section view of the trim panel of FIG. 2 taken along line 3-3 in FIG. 2 according to an exemplary embodiment.

FIG. 4 is a front perspective view of a decorative film or element prior to trimming according to an exemplary embodiment.

FIG. 5 is a front perspective view of a coverstock prior to trimming according to an exemplary embodiment.

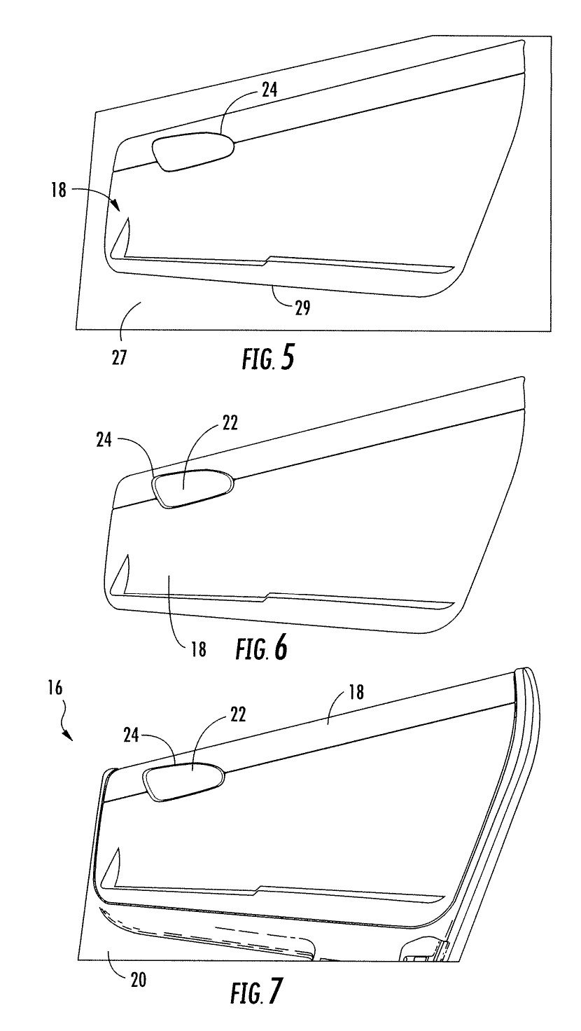

FIG. 6 is a front perspective view of the decorative element of FIG. 4 coupled to the coverstock of FIG. 5 according to an exemplary embodiment.

FIG. 7 is a front perspective view of an “A” surface of a door trim panel formed by a substrate molded behind the coverstock and decorative element of FIG. 6 according to an exemplary embodiment.

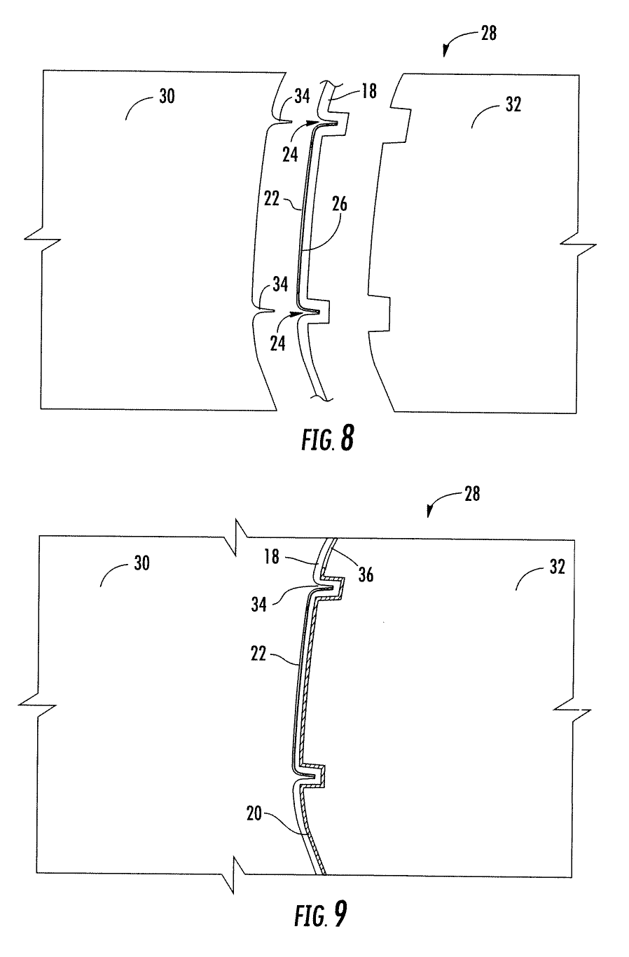

FIG. 8 is cross-section schematic of a coverstock and decorative element within a mold according to an exemplary embodiment.

FIG. 9 is a cross-section schematic of the mold of FIG. 8 closed to form a gap between the coverstock and a portion of the mold according to an exemplary embodiment.

### DETAILED DESCRIPTION

Referring to FIG. 1, a vehicle 11 is shown according to an exemplary embodiment. Vehicle 11 includes a vehicle interior 10 (e.g., a passenger compartment, etc.). While vehicle 11 is shown as an automobile, it should be understood that according to various alternative embodiments, vehicle 11 could be any of a wide variety of vehicles, including sport utility vehicles, buses, recreational vehicles, airplanes, etc., and the teachings herein extend to all such applications.

FIG. 2 shows a perspective view of vehicle interior 10 in greater detail. Interior 10 is shown to include a door 12 and an instrument panel 14. Door 12 and instrument panel 14 each may comprise an outer trim component or panel 16 that is formed by a coverstock (e.g., a flexible member, skin, sheet, foil, etc., all of which will be referred to as coverstock 18) coupled to a substrate (e.g., a rigid member, base, panel, etc., all of which will be referred to as a substrate 20) for structural support. Trim panel 16 also includes a decorative element 22 coupled to coverstock 18 to provide a desired ornamental appearance and/or a functional component. For the purposes of this disclosure, trim panel 16 coupled to door 12 will be further described, but it should be understood by a person having ordinary skill in the art reading this disclosure that trim panel 16 could be coupled to instrument panel 14, or other surfaces within vehicle 11, or used in other applications where a panel with multiple decorative elements is desired (e.g., in applications not involving a vehicle such as vehicle 11).

According to one embodiment, substrate 20 provides the substantial, if not the entire, structural support for trim panel 16 generally, and may provide structural support to various components that are attached to trim panel 16 (e.g., armrests, speakers, handles, etc.). Substrate 20 may further provide an ornamental or decorative appearance. Surfaces of trim panel 16 that are visible (e.g., to an occupant) when trim panel 16 is mounted in vehicle interior 10 are generally referred to as the “A” surface or side. Portions or surfaces of substrate 20 may provide an “A” surface. Other portions or surfaces of substrate 20 may be obscured or covered by coverstock 18, decorative element 22, or other components. According to an exemplary embodiment, substrate 20 is a rigid structure and is formed by injection molding a polymer resin in a process that uses heat and pressure to inject a molten resin into a cavity formed in a mold tool.

According to various exemplary embodiments, substrate 20 may be made from a variety of suitable materials. For example, injection molded polypropylene is one method and material for making substrate 20, but other materials can be used, including other thermoplastic resins such as polyethylene, acrylonitrile butadiene styrene (“ABS”), polyurethane nylon, any of a variety of homopolymer plastics, copolymer plastics, plastics with special additives, filled plastics, etc. Also, other molding operations may be used to form these components, such as injection compression molding, etc.

Coverstock 18 may provide an ornamental or decorative appearance to trim panel 16 using different materials, textures, colors, treatments, secondary operations (e.g., sewing), or the like. Coverstock 18 may also provide a functional feature to trim panel 16, such as a soft or cushioned portion or region of trim panel 16 (e.g., a softer portion of trim panel 16 relative to substrate 20), a raised portion of trim panel 16, a different surface compared to substrate 20, or the like. According to exemplary embodiments, a substantial portion of one side of coverstock 18 serves as part of the “A” surface of trim panel 16. According to an exemplary embodiment, coverstock 18 comprises a plurality of layers to form a laminate. According to an exemplary embodiment, coverstock 18 comprises a foam layer between two polymer layers. Alternatively, coverstock 18 may be formed by a single layer. Coverstock 18 may be a single, unitarily formed, integral sheet, or a plurality of sections (e.g., layers, patches, etc.) coupled together (e.g., sewn, fastened, bonded, etc.). Coverstock 18 may be manufactured from a sheet of material (e.g., in flat sheets, or rolls, etc.).

According to an exemplary embodiment, coverstock 18 is made from a laminate of a vinyl layer, a polypropylene foam layer, and a polypropylene layer, but can be made from any of a variety of materials and compositions including fabric, cloth, natural material (e.g., leather, etc.), textile (e.g., woven, non-woven, knit, etc.), polymer (e.g., thermoplastic elastomer polyolefin (TPO), materials formed by reaction injection molding (RIM), etc.), elastomer, or the like or combinations thereof; and may have multiple layers (e.g., outer, inner, scrim, etc.).

Decorative element 22 is coupled to coverstock 18 and generally refers to a film, sheet, or the like that according to one embodiment provides a decorative effect, rather than a structural support to another component. According to an exemplary embodiment, instead of welding decorative element 22 to coverstock 18, coverstock 18 is formed with a groove 24 (e.g., a ditch, indentation, notch, perforation, etc.) to accept decorative element 22, as shown in FIG. 3. A portion of decorative element 22, shown as a projection or flange 23, is disposed in groove 24. Decorative element 22 may be partially or entirely disposed or located in a recess 21 (e.g., pocket, indent, indentation, etc.) in coverstock 18 so that the decorative element 22 is substantially flush (e.g., coplanar, etc.) or recessed from the surface of coverstock 18. Alternatively, recess 21 may be more shallow so that decorative element 22 protrudes past the surface of coverstock 18.

According to one embodiment, decorative element 22 may comprise a decorative layer coupled to a backing layer such as a decorated acrylic top layer and a acrylonitrile butadiene styrene (“ABS”) or thermoplastic elastomer polyolefin (TPO) backing layer. Alternatively, decorative element 22 may be formed of aluminum or other decorative materials such as wood laminates and may be attached and/or in-molded using the processes described herein. According to an exemplary embodiment, decorative element 22 is made from flexible and/or compressible materials. According to alternative embodiments, decorative element 22 may be any of a variety of flexible or rigid members intended for disposition on the A-surface of coverstock 18.

According to an exemplary embodiment, decorative element 22 is coupled to coverstock 18 by an adhesive 26 (see, e.g., FIG. 8), such as a pressure sensitive adhesive. “Pressure sensitive” generally refers to the category of adhesives that adheres to surfaces upon contact and application of pressure. The bonding strength of adhesive 26 will depend on the adhesive used as well as the amount of pressure applied to the components being bonded. The pressure sensitive adhesive may be applied to one or both of the components being joined, may be applied on the entire or a portion (e.g., the flange 23, the groove 24, etc.) of the surface(s) that will contact, and/or may be applied to a backing such as a tape.

According to an alternative embodiment, adhesive 26 is heat activated by heat provided by an independent heat source, provided by one or more of the process steps described in greater detail herein (such as the molding of the substrate 20), or the like. According to an exemplary embodiment, adhesive 26 is a pressure sensitive adhesive that becomes set during the subsequent molding operation (as further explained below).

According to an exemplary embodiment, adhesive 26 is intended to allow decorative element 22 to bond (e.g., adhere, etc.) mechanically and/or chemically sufficiently to coverstock 18 for handling and insertion into an injection-molding tool where molten resin is injected to form substrate 20. The high pressure of the molten resin being injected into the tool compresses coverstock 18 against decorative element 22, fully activating adhesive 26 to create a high strength bond between coverstock 18 and decorative element 22. According to an exemplary embodiment, adhesive 26 is applied to the decorative element 22, to the coverstock 18, to both, etc. prior to the injection molding process. For example, adhesive 26 may be applied during the fabrication process, such as after decorative element 22 and/or coverstock 18 are formed and before decorative element 22 is brought together with coverstock 18.

According to one embodiment, adhesive 26 may be a generally available film adhesive. Alternatively, adhesive 26 may be any of a variety of web, spray, and/or liquid adhesives, etc.

According to the various exemplary embodiments illustrated herein, decorative element 22 may provide any of a variety of ornamental appearances such as colors, textures, patterns, images, indicia, text, designs, or combinations thereof that are formed, added, provided on, printed on, painted on, or otherwise disposed on the side or surface of coverstock 18 that ultimately at least partially faces vehicle interior 10 (e.g., the visible or “A-surface”).

Referring now to FIGS. 4-7, a process for making trim panel 16 according to an exemplary embodiment will be discussed in greater detail. Referring to FIG. 4, before decorative element 22 is coupled to the coverstock 18, decorative element 22 is formed to a desired shape (e.g., three-dimensional configuration) having one or more projections (e.g., flanges, down-turned edges, etc., which will be referred to as flanges 23). According to an exemplary embodiment, decorative element 22 is thermoformed using a combination of heat and pressure/vacuum on a sheet of material. Alternatively, decorative element 22 may be formed by any of a variety of processes. Multiple decorative elements 22 may be thermoformed in a single sheet, which may then be subsequently used separately or at different locations on trim panel 16. Decorative element 22 is then trimmed to a desired shape to remove excess material 25. Decorative element 22 may be trimmed or die-cut after being thermoformed. Alternatively, decorative element 22 may be trimmed before or while being formed. Flange 23 may form a continuous member about the periphery of decorative element 22. Alternatively, a series of flanges 23 may be provided.

Referring now to FIG. 5, separately (e.g., before, concurrently with, or after the fabrication of decorative element 22), coverstock 18 is formed to a desired shape (e.g., three-dimensional configuration). According to an exemplary embodiment, coverstock 18 is thermoformed using a combination of heat and pressure/vacuum on a sheet of material. Alternatively, coverstock 18 may formed by any of a variety of processes. Coverstock 18 is then trimmed to a desired shape to remove any excess material 27, for example, by trimming coverstock 18 at a perimeter or edge 29. Coverstock 18 may be trimmed or die-cut after being thermoformed. Alternatively, coverstock 18 may be trimmed before or while being formed. The forming process of coverstock 18 provides or creates groove 24, which, as discussed in greater detail below, is used to receive flange 23 of decorative element 22. Groove 24 corresponds to the configuration (e.g., shape, thickness, depth, spacing, etc.) of flange 23. The forming process also provides recess 21 or other features, curvature, or the like in coverstock 18.

Referring to FIG. 6, according to one embodiment, adhesive 26 (see FIG. 3) is applied to decorative element 22 and/or coverstock 18. Adhesive 26 may be applied prior to the forming/trimming of decorative element 22 and/or the coverstock 18, or at any time before these components are coupled together. Adhesive 26 may be applied to a surface or to a portion (e.g., flange 23, groove 24, etc.) of decorative element 22 and/or coverstock 18. Decorative element 22 is coupled (e.g., bonded, joined, connected, etc.) to the coverstock 18 by adhesive 26 and by flanges 23 formed in decorative element 22 engaging (e.g., pressed or press-fit into) groove 24 formed in coverstock 18. This coupling of decorative element 22 and coverstock 18 does not necessarily provide a permanent or final joining of the components. The strength of the bond between decorative element 22 may be increased according to exemplary embodiments.

Referring to FIG. 7, substrate 20 is then molded behind, or partially molded behind, coverstock 18. The heat and/or pressure of substrate 20 being molded behind coverstock 18 is intended to further activate adhesive 26 on the back of decorative element 22. For example, according to one embodiment, the pressure provided by the injected resin that forms substrate 20 further sets the adhesive bond between decorative element 22 and coverstock 18.

Referring now to FIGS. 8 and 9, a process for joining coverstock 18 and decorative element 22 and forming substrate 20 according to an exemplary embodiment will be discussed in greater detail. FIG. 8 shows a mold 28 having a first mold section (shown as a cavity 30) and a second mold section (shown as a core 32). Coverstock 18 is coupled to cavity 30 when mold 28 is open. According to an exemplary embodiment, coverstock 18 is mounted on cavity 30 by projections 34 extending from cavity 30 engaging groove 24 on coverstock 18 (e.g., in a “press fit” engagement). FIG. 8 shows coverstock 18 in front of projections 34 just prior to mounting coverstock 18 to cavity 30. Projections 34 are intended to position and to retain coverstock 18 and decorative element 22 in mold 28. Alternatively, coverstock 18 may be suspended (e.g., hang) from pins, placed in mold 28 by any of a variety of techniques including robotic placement, manual placement, vacuum device, adhesive, or the like, and may be held in place by its shape registering with the shape of mold 28, etc.

Mold 28 closes (or partially closes) around coverstock 18 (e.g., by moving mold sections 30, 32 toward each other or one of the sections towards the other section) so that a gap 36 (e.g., a cavity, space, etc.) is provided between core 32 and cavity 30 (see FIG. 9).

Referring to FIG. 9, molten polymer resin is then injected into gap 36 between core 32 and coverstock 18 to form substrate 20. As molten plastic resin fills gap 36, coverstock 18 is pressed against decorative element 22 and against the surface of core 32. Coverstock 18 is pressed against decorative element 22 by the pressure and/or heat of the plastic resin to further bond decorative element 22 to coverstock 18. The pressure of the injected plastic sets adhesive 26 and forms a strong bond between decorative element 22 and coverstock 18. After the plastic resin has sufficiently solidified, panel 16, now including substrate 20, coverstock 18, and decorative element 22, is removed from mold 28 upon release of the injection pressure. Upon removal from mold 28, decorative element 22 may expand (e.g., if made of or with a compressible material) and return to, or near to, its pre-molding thickness. The presence of decorative element 22 in mold 28 during the injection of the plastic resin may cause substrate 20 to form around the decorative element 22.

After the plastic resin forms substrate 20, trim panel 16 can undergo any of a variety of finishing operations (e.g., removing any portions of coverstock 18 not attached to substrate 20 (e.g., a portion or strip containing apertures), wrapping around and coupling to the B surface of substrate 20 (e.g., by fasteners, adhesives, welding, heat staking, or the like), etc.

It is to be understood that the invention is not limited to the details of construction and the arrangement of the components set forth in the foregoing description or illustrated in the drawings. The invention is capable of other embodiments or being practiced or carried out in various ways. The molded article described in this disclosure may be employed in a variety of applications, and is generally usable with any application where it would be beneficial to provide a decorative element with a coverstock. When the molded article is a trim panel for use in a vehicle, it is suitable for use in an interior passenger compartment of a vehicle, and may find utility in the form of door panels, dashboards, instrument panels, consoles, sidewall trim, overhead liners, or other vehicle components or portions thereof. While the disclosed embodiments may be described with respect to a vehicle trim panel, such as a door panel, the features of the disclosed embodiments are equally applicable with other applications such as other panels, molded articles and components and other office, home, or educational, industrial, commercial, or consumer products which employ localized areas or regions of various or different ornamental appearances. It is also to be understood that the phraseology and terminology employed herein is for the purpose of description and should not be regarded as limiting. For example, the terms “substrate,” “coverstock,” and “decorative element” are intended to be broad terms and not terms of limitation. These components may be used with any of a variety of products or arrangements and are not intended to be limited to use with automotive applications.

It is also important to note that the construction and arrangement of the elements of the method of attaching a decorative element and a vehicle component as shown in the exemplary embodiments are illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present inventions. Other substitutions, modifications, changes and omissions may be made in the design, operating conditions and arrangement of the exemplary embodiments without departing from the spirit of the present inventions.

What is claimed is:

1. A method of making a vehicle panel, comprising:
forming a coverstock;
forming a decorative element to at least partially conform to the coverstock;
positioning the coverstock and the decorative element into a mold; and
molding a substrate to the coverstock, thereby bonding the decorative element to the coverstock.

2. The method of claim 1 further comprising die cutting the coverstock and the decorative element.

3. The method of claim 1 further comprising:
providing an adhesive on at least one of the decorative element and the coverstock;
wherein molding the substrate to the coverstock comprises increasing at least one of a temperature and a pressure within the mold; and
wherein bonding the decorative element to the coverstock comprises activating the adhesive as a result of increasing at least one of the temperature and the pressure within the mold.

4. The method of claim 1 wherein forming the coverstock includes thermoforming a groove in the coverstock and wherein forming the decorative element includes thermoforming a flange on the decorative element.

5. The method of claim 4 further comprising:
thermoforming a recess into the coverstock configured to receive the decorative element;
wherein a surface of the decorative element is substantially coplanar with a surface of the coverstock after the decorative element is bonded to the coverstock.

6. The method of claim 1 wherein the flange extends around substantially the entire periphery of the decorative element.

7. A method of making a molded article comprising:
providing a coverstock having a groove, and a decorative element having a flange;
applying the decorative element to the coverstock such that the flange engages the groove;
positioning the coverstock and the decorative element in a mold; and
introducing a substrate material into the mold to form a substrate.

8. The method of claim 7 further comprising:
providing an adhesive on at least one of the decorative element and the coverstock;
wherein introducing a substrate material into the mold further comprises activating the adhesive to bond the decorative element to the coverstock.

9. The method of claim 8 wherein the adhesive is at least one of a pressure sensitive adhesive and a heat activated adhesive.

10. The method of claim 7 further comprising:
thermoforming the coverstock to a desired shape; and
thermoforming the decorative element to at least partially conform to the desired shape.

11. The method of claim 7 wherein the flange extends around substantially the entire periphery of the decorative element.

12. The method of claim 11 wherein the coverstock includes a recessed portion configured to receive the decorative element.

13. The method of claim 12 wherein a surface of the decorative element is substantially coplanar with a surface of the coverstock after the decorative element is bonded to the coverstock.

14. The method of claim 7 wherein the decorative element is a compressible element.

15. A molded article comprising:
a coverstock comprising a groove;
a decorative element coupled to the coverstock by an adhesive and having a flange at least partially received within the groove; and
a substrate molded behind the coverstock.

16. The molded article of claim 15 wherein the flange extends around substantially the entire periphery of the decorative element.

17. The molded article of claim 15 wherein the adhesive is a pressure sensitive adhesive.

18. The molded article of claim 17 wherein the adhesive is a heat activated adhesive.

19. The molded article of claim 15 wherein the substrate comprises a recess, and wherein the decorative element is provided at least partially within the recess.

20. The molded article of claim 19 wherein a surface of the decorative element is substantially coplanar with a surface of the coverstock.
